(19) United States
(12) Patent Application Publication
(10) Pub. No.: US 2021/0206562 A1
(43) Pub. Date: Jul. 8, 2021

(54) TAMPER-RESISTANT SYSTEM FOR DELIVERING PRE-PACKAGED GOODS, AND METHODS OF USING SAME

(71) Applicant: David W. WAWRZYNSKI, ROSEVILLE, MI (US)

(72) Inventor: David W. WAWRZYNSKI, ROSEVILLE, MI (US)

(21) Appl. No.: 17/140,775

(22) Filed: Jan. 4, 2021

Related U.S. Application Data
(60) Provisional application No. 62/956,841, filed on Jan. 3, 2020.

(51) Int. Cl. B65D 88/22; G06Q 50/30

(52) U.S. Cl. CPC B65D 88/22; B65D 2401/05; G06Q 50/30

(57) ABSTRACT

A tamper-resistant system for delivering pre-packaged goods includes a container configured to receive pre-packaged goods therein; a label configured to be applied across an opening of the container such that the pre-packaged goods received in the container are not accessible without visibly, permanently damaging one or both of the label and the container; and a workflow program including a customer segment to be used by customers and intended recipients, a vendor segment to be used by vendor, and a delivery segment to be used delivery personnel. The vendor segment is configured to produce the label having information provided thereon regarding the pre-packaged goods, and a scannable code. During the delivery process, the delivery personnel is allowed to contact via a mobile device by scanning the scannable code which includes contact information of the intended recipient without the delivery personnel gaining access to the contact information of the intended recipient.

### CROSS-REFERENCE TO RELATED APPLICATIONS

The present application claims priority under 35 USC § 119 to U.S. Provisional Patent Application No. 62/956,841, filed on Jan. 3, 2020. The entire subject matter of this priority document, including specification, claims and drawings thereof, is incorporated by reference herein.

### BACKGROUND OF THE INVENTION

### Field of the Invention

The present invention relates to a tamper-resistant system for delivering pre-packaged goods, particularly goods which may be eaten or taken internally by humans, which provides real time information regarding the delivered goods, and a method of using same. More particularly, the present invention pertains to such an anti-tampering system (temper-resistant system) which may be applied to the packaging of any type of delivered goods, including restaurant-prepared foods, by which the recipient will be able to readily monitor the delivered goods in real time and determine whether the delivered goods have been tampered with, and which is also easy to use and inexpensive, as well as methods of using same.

### Description of the Background Art

There are many known seals and other anti-tampering devices which may be applied to packaging of delivered goods which inhibit tampering with the goods during the delivery process. For example, such closure seals and other devices are conventionally applied to packaging for prepared foods from restaurants and mail order medications which are being delivered to customers. The known seals and other anti-tampering devices are certainly an improvement over other conventional practices, such as stapling shut the opening of container used for prepared food delivery, which may be removed and replaced by other staples without any clear visible indication of same, and which have other undesirable characteristics, e.g., ending up in the delivered food, poking one's self in the finger, etc. The known closure seals and other devices include those devices disclosed in the following Patents and Patent Application Publications:
JP H 03-289465 A Label Sealing Method For Package . . . and Preventing Tampering Thereof;
U.S. Pat. No. 5,866,183: Package Closing Label;
U.S. Pat. No. 5,971,262: Tamper-Resistant Container For Freshly Baked Food Products;
U.S. Pat. No. 6,169,270 B1: Sealed Food Container And Method of Assuring Delivery of the Container in a Heated State;
U.S. Pat. No. 6,343,695 B1 Labeled Medical Container Assembly;
US 2010/0181371 A1: Tamper Evident Label;
US 2016/0304234 A1: Tamperproof Food Box;
US 2017/0305630 A1: Method of Securing Food;
WO 2018/234357 A1: Anti-Tampering Assembly and System.

While the known labels and devices are generally suitable for their intended functions, they remain to be improved on in terms of reliably indicating whether the contents of a container have been accessed during the delivery process, convenience in use, cost, etc. For example, many of the known devices are essentially adhesive labels which are applied across an openable/closable portion of a container such as a cardboard box, a plastic clamshell and an insulated bag, and in order to open the container to access the contents thereof it is necessary to rupture—break the label. When the consumer receives the delivered goods, the presence of a ruptured—broken label provides a clear indication that the container has been opened after the label was initially applied to the container. The known labels may provide some additional information, including information identifying the goods in the container, a bar code for scanning at a cash register or other device, an indication of whether the container has been maintained in a properly heated condition, advertisements, etc., and the known labels may include a component for easily rupturing or breaking same such as a perforated tear strip. While such labels are relatively simple in structure such that they are correspondingly inexpensive, they only provide a limited amount of information about the delivered goods and do not permit real time monitoring of same. Further, because these labels typically are formed using permanent type adhesives, during the process of applying the labels to the containers, once they are even partially applied/adhered to a container, it is very difficult to change or adjust the orientation of the labels relative to the containers in order to ensure that they are properly applied to the proper portions of the containers.

On the other hand, some of the known devices are relatively complex and expensive, which may be unsuitable for delivery of goods which themselves are not particularly expensive such as hot, prepared foods from restaurants. For example, the Anti-Tampering Assembly and System of WO 2018/234357 A1 includes an RFID passive tag, a tampering track of conductive material connected to the passive RFID tag and an actuating unit which is configured to recognize when the container has been tampered with and to actuate an alarm and transmit an alarm message which may be received by a remotely located receiving device. Such Assembly and System may be very effective at detecting and deterring tampering, but the cost of same is prohibitive for many applications. As other examples, the Tamper-Resistant Container For Freshly Baked Food Products of U.S. Pat. No. 5,971,262 includes a rupturable label together with a special container with tamper-resistant ventilation which prevents contaminants from being easily injected into the container therethrough, while the Tamperproof Food Box of US 2016/0304234 A1 is a unique container with adhesive closure flaps or the like which may be sealed after food is placed in the container, and perforated tear strip(s) provided in association with the closure flaps which are removed to initially open the sealed container, but the container is reclosable after the tear strips are removed. Again, the special containers disclosed in these examples would add a significant cost to the goods being delivered.

Moreover, restaurant delivery services and medication delivery services are becoming more and more popular in recent years and spawning a huge expansion in the hot, prepared food delivery industry. With the expansion of the industry there is a corresponding increase in concern by the general public of the delivered goods being tampered with by persons involved in the delivery process, e.g., delivery personnel consuming some of the goods being delivered or adding undesirable things to the goods that are being delivered. Current news outlets regularly include stories relating to tampering misdeeds by food delivery service personnel, and reflects the increasing significance of such tampering for this significantly expanding area of business, and the need to curtail such tampering.

Hence there remains a need in the art for an anti-tampering system which can reliably provide an indication to the recipients of the delivered goods whether or not a delivered package has been tampered with, as well as provide significant additional real-time information to the recipients regarding the goods being delivered, and yet is relatively inexpensive and easy to use.

### SUMMARY OF THE INVENTION

It is an object of the invention to provide a device which satisfies the discussed need, and a method of using same.

According to one aspect of the present invention a tamper-resistant system (also referred to as anti-tempering system) for delivering pre-packaged goods prepared by a vendor is provided. The tamper-resistant system includes a container configured to receive pre-packaged goods therein; a label configured to be applied across an opening of the container such that the pre-packaged goods received in the container are not accessible without visibly, permanently damaging one or both of the label and the container; and a workflow program comprising a plurality of segments including a customer segment to be used by customers and intended recipients, a vendor segment to be used by vendor who is preparer and packager of goods, and a delivery segment to be used delivery personnel. The vendor segment is configured to produce said label having information provided thereon regarding the pre-packaged goods, a person who placed pre-packaged goods in said container, an entity who prepared the pre-packaged goods, a delivery personnel, an intended recipient, and a barcode; and to selectively provide real time information pertaining the pre-packaged goods and a status of delivery of the pre-packaged goods to an intended recipient. During the delivery process, the delivery personnel is allowed to contact via a mobile device by scanning the barcode which includes contact information of the intended recipient without the delivery personnel gaining access to the contact information of the intended recipient.

According to another aspect of the present invention, there is provided an anti-tampering system for packaging of delivered goods which comprises a container configured to receive and enclose therein pre-packaged goods to be delivered; and an adhesive label which is configured to be applied to the container for sealing an opening of the container, wherein an adhering surface of the adhesive label has first and second sections spaced from each other with stronger-bonding adhesive provided on the first section and weaker bonding adhesive provided on the second section such that the first and second sections may be adhered to the container for sealing an opening of the container, and an exposed or opposite surface of the adhesive label has information provided thereon pertaining to the pre-packaged goods which are to be received and enclosed in the container. The information provided on the opposite surface of the label is configured to be assist an intended recipient to easily and promptly, visually verify propriety of the pre-packaged goods when the container having the prepackaged goods enclosed therein is delivered to the intended recipient. Additionally, the information may include a tracking code and an associated application for a smart device that are configured to permit information pertaining to the container to be uploaded so that the information may be monitored in real time by the intended recipient while the container enclosing the pre-packaged goods is in the process of being delivered.

In the anti-tampering system according to the first aspect of the invention the container may desirably be any type of container, including a thin-walled plastic bag commonly used for bagging retail goods that are being sold to a consumer, a paper bag, a box, a plastic clam-shell, hinged container, etc., and the container may include information printed thereon identifying a source of the pre-packaged goods, etc. The material(s) forming the adhesive label and the stronger adhesive provided on the first section of the adhering surface of the adhesive label are configured such that once the label is applied to the container with the first and second sections adhered to the container, the goods within the container cannot be accessed without causing permanent, visible damage to at least one of the label and the container. On the other hand, the weaker adhesive provided on the second section of the adhering surface of the adhesive label is configured such that once applied to the container the second section can be removed from the container without causing any damage to the adhesive label or the container, for thereby permitting the label to be carefully positioned and repositioned relative to the container via the second section before the first section having the stronger adhesive is bonded to the container.

The information provided on the opposite surface of the adhesive label includes at least one of: a description of the pre-packaged goods, a partial phone number, name and/or other information identifying the intended recipient, identity of personnel who enclosed, confirmed and/or sealed the prepackaged goods in the container using the label, identity of personnel and/or service who delivered the container enclosing the pre-packed goods to the intended recipient, a total number of sealed containers included with a particular delivery, the time when the delivery personnel took possession of the container enclosing the pre-packed goods, estimated delivery arrival time, a receipt which may be removed from the label, etc. Such information not only helps the intended recipient to readily understand whether the order of delivered goods as received is proper, but also helps to assure that persons identified as being involved in the food preparation and delivery process will be more attentive to what they are doing as any mistakes they make in relation to the delivered goods are more likely to be traced back to them. The information may also include tracking code(s) for the sealed container, and the tracking code(s) may be linked to a smart phone application and/or a publicly accessible web address or website which may be accessed using any appropriate device such as a tablet or portable computer, a smart phone, a PC type computer, a laptop computer, etc., whereby the intended recipient may obtain real time data regarding the delivery.

The anti-tampering system according to the first aspect of the invention provides several advantages over known anti-tampering devices. One advantage is that it is non-complex and relatively inexpensive, but is appropriate for providing sufficient, effective anti-tampering protection to the recipients of the delivered goods for essentially any pre-packaged good that is being delivered. For example, because the container may be of any type, it would be appropriate to use containers that the entity providing the pre-packaged goods already has in stock, and which may include the entity's name, trademark and/or promotional information provided thereon, and such that it is not necessary to use any special container dedicated to the purpose of delivering the prepackaged goods. Another advantage is that the adhesive label with one surface having the first and second sections with stronger and weaker adhesives provided thereon can be carefully positioned and repositioned on the container without compromising the integrity of the label or the container using the second section having the weaker adhesive thereon, and once the label is positioned as desired on the container the first section having the stronger adhesive thereon may then be adhered to the container for securely closing the opening of the container. Of course, it is also possible to use a label having only a stronger, permanent adhesive thereon according to the present invention. Still another advantage is that the adhesive label, or a plurality of the labels, is fully sufficient for closing and sealing any container such that no substantial portion of the container may be accessed without creating some permanent, visible change to the label or to the sealed container that will be very apparent to the intended recipient who receives the delivered goods. Yet another advantage is that the container may be properly sealed without the use of staples, as is very common with restaurants and delivery services.

According to a second aspect of the present invention, the system may further comprise a printer, such as a thermal printer or other appropriate type of printer, which is configured to print the information and tracking code(s) on the adhesive label so that the information will accurately correspond to the goods in the container and will be legible so that all parties involved can readily verify the information pertaining to the delivered goods, including when delivery of the container actually began and the condition of the sealed container at that time. Further, it is common to have multiple in an order for delivering pre-packaged goods to an intended recipient, e.g., a large order for delivered foods from a restaurant will often include two or more containers for the delivered foods. Having a printer allows multiple, identical or substantially identical labels to be printed that may be used to respectively seal the multiple containers. Of course, the multiple labels could be could be slightly differentiated from each other, e.g., by printing thereon 1 of 2, 2 of 2 and the like, which also helps the intended recipient know whether the entire order has been delivered.

The anti-tampering system according to the first aspect and second aspects of the invention is very advantageous because the printed information appearing on the label can be determined concurrently as or immediately after the pre-packaged goods are enclosed in the container so that the information can be as accurate as possible, unlike information which is generated in advance without any particular specificity to the pre-packaged goods which are being delivered. Another advantage is that the label may contain thereon all the relevant information pertaining to the delivered goods, so that the recipients of the delivered goods can readily determine from such information, as well as from the condition of the label and the container at the time of delivery, whether the goods are what the recipients ordered and whether the goods may have been tampered with during the delivery process. Also, the printed information on the label will be more legible and understandable by the recipients of the delivered goods than information conventionally provided on packages from restaurant delivery services which is hand written or scribbled onto a package with a marker or other writing instrument. Similarly, it would be much more difficult to modify the printed information during the delivery process in a manner that the intended recipient would not notice, as compared to information which is simply hand written on the label or container with a marker. Of course, restaurants may choose to hand write some or all of the information on the labels if they so choose, while still using other aspects of the system, e.g., if only the scannable code 17 is printed on the label by the printer, it is still possible to use the sealing system to achieve most of the advantages of the system as discussed herein.

According to a third aspect of the present invention, the system may further include a smart phone application or a publicly accessible web site or web address associated with the tracking code, and which permits real time information pertaining the delivered goods to be uploaded and transmitted to the intended recipients of the goods. Such information may include time, location and estimated time of delivery, and may also give the intended recipient an option to come pick up the goods themselves and cancel the delivery. Similarly, the app may permit customers to originally place orders with restaurants which the customers intend to pick up themselves, and when the order is ready for pickup the restaurant may send the customers texts or emails informing that the orders are ready for pick up, while giving the customers an option to change the order from pick up to delivery. Additionally, such information may include images of the container containing the prepackaged goods and sealed with the adhesive label, e.g., images taken at the time when delivery personnel take possession of the container to so that the recipients of the delivered goods may easily verify when delivery of the container actually began and the condition of the container at that time. Still further, the app may permit customers to submit claims for damages or mistakes, post comments, whether good or bad, regarding the delivered goods, the delivery service, etc.

The anti-tampering system according to the first aspect and third aspects of the invention is also very advantageous because it provides further real time information to the intended recipients regarding the goods being delivered, which is very helpful for providing additional consumer confidence and satisfaction in the goods delivery process, and yet adds little cost to the anti-tampering system.

According to a other aspects of the present invention, in addition to any of the first-third aspects, the label may include a weakened portion which permits the label to be easily ruptured by the intended recipient once he/she receives the sealed container containing the delivered goods, and the label may be colored specific color(s), e.g., orange, as an indication of its source and integrity.

### INTENT OF DISCLOSURE

Although the following disclosure offered for public dissemination is detailed to ensure adequacy and aid in understanding of the invention, this is not intended to prejudice that purpose of a patent which is to cover each new inventive concept therein no matter how it may later be disguised by variations in form or additions of further improvements. The claims at the end hereof are the chief aid toward this purpose, as it is these that meet the requirement of pointing out the improvements, combinations and methods in which the inventive concepts are found. There has been chosen a specific exemplary embodiment of to an anti-tampering system for packaging of delivered goods according to the invention and specific alternative structures and modifications thereto, the embodiment having been chosen for the purposes of illustration and description of the structure and method of the invention are shown in the accompanying drawings forming a part of the specification.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a front view of components of an exemplary embodiment of an anti-tampering system according to the present invention, including a container and an adhesive label.

FIG. 2 is a plan view of one surface of the adhesive label in the embodiment of FIG. 1.

FIG. 3 is a perspective view of the embodiment of FIG. 1 in which pre-packaged goods to be delivered are enclosed and sealed within the embodiment of the anti-tampering system shown in FIG. 1.

FIG. 4 is a front view of components of another exemplary embodiment of an anti-tampering system according to the present invention.

FIG. 5 is a plan view of another label which may be used according to another exemplary embodiment of the present invention suitable for use with a container having a projecting handle.

FIG. 6 is a plan view of another label which may be used according to another exemplary embodiment of the present invention and which includes a weakened portion which may be easily ruptured.

FIG. 7 is a flowchart of a process for uploading and transmitting real time information regarding prepackaged goods which are being delivered to a smart phone application, a publicly accessible web site or web address associated with tracking code(s) provided on the label according to an exemplary embodiment of the present invention.

FIG. 8 is a view of a customer segment of a workflow program (application flow chart).

FIG. 9 is a view of a vendor segment of a workflow program.

FIG. 10 is a view of a delivery segment of a workflow program.

### DETAILED DESCRIPTION OF PRESENT EXEMPLARY EMBODIMENTS

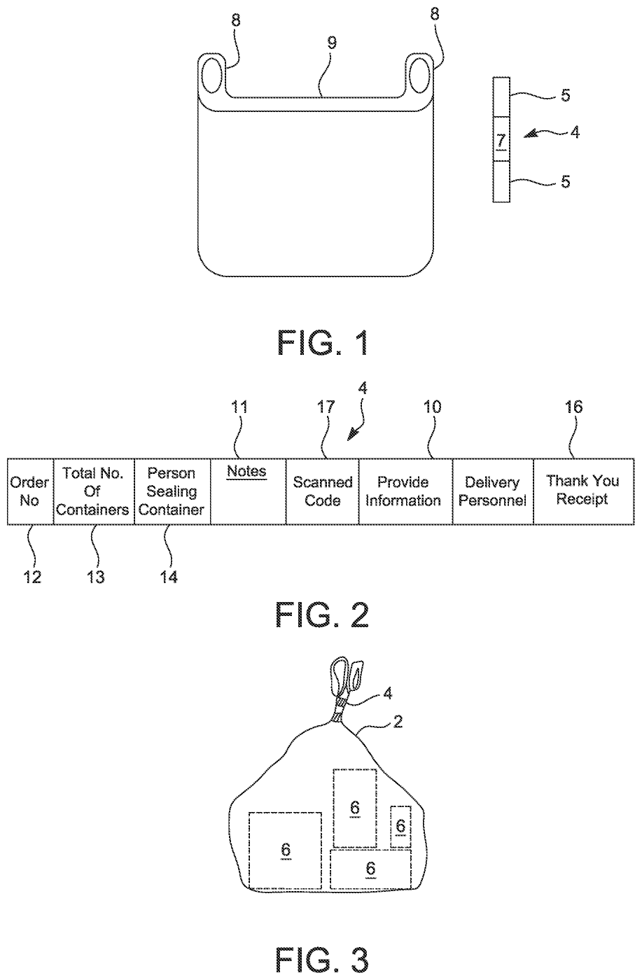

With reference to FIGS. 1-3, there is shown an exemplary embodiment of an anti-tampering system according to the present invention, with FIG. 1 separately showing a container 2 and an adhesive label 4 of the system, FIG. 2 showing an enlargement of one side of the adhesive label having various information provided thereon, and FIG. 3 showing pre-packaged goods to be delivered which are enclosed within the container and an opening of the container sealed closed by the adhesive label.

The container 2 according to this embodiment may be any type of container having an opening which may be sealed in a closed state using the adhesive label 4 of this embodiment, which includes essentially all or most known containers. As depicted the container 2 may be a thin-walled plastic bag commonly used by retailers for packaging purchased goods therein, and which is typically formed of some type of polyethylene, e.g., high molecular weight (HMW) polyethylene or linear low-density (LLD) polyethylene, and is commonly referred to as a “T-shirt” bag. Other types of containers which may be used in the exemplary embodiment of the invention include paper bags, fabric bags, other types of plastic bags, boxes made of various materials, plastic clam-shell type containers, other hinged containers, etc. Because the container may be of any type, it would be appropriate to use containers that the entity providing the pre-packaged goods already has in stock, and such that it is not necessary to use any special container, which is desirable for reducing cost of the system. The container may include various information printed thereon, including trademarks and other information identifying a source of the pre-packaged goods, etc.

While thin-walled plastic bags are very inexpensive and may be torn or ruptured using a knife of other sharp implement, they are nonetheless appropriate for containing pre-packaged goods and use by delivery services delivering the pre-packaged goods in the exemplary embodiment of the present invention as they can securely hold the pre-packaged goods therein, can be sealed in a closed condition using an adhesive label and will be permanently damaged if the label is removed from the container.

The adhesive label 4 may be of any appropriate length and width suitable for securely closing and sealing the opening of the container 2. For example, the label may be may be 0.5-2.0 inches wide and 4.0-12.0 inches long, and its main body may be made of any appropriate material such as paper, plastic, recyclable material, and/or fabric, provided that the label cannot be removed from the container without causing visible damage to the label and/or the container once the label is fully bonded to the container. Further, portion(s) of the label may be structured to easily break/rupture or otherwise become visibly damaged if someone attempts to remove the label from the container 2 after the label is fully attached to the container 2, e.g., the label may have a weakened portion at which it may be easily ruptured, such as the label 34 including weakened portion 36 in FIG. 6. The label 4 may include a first side having various types of information printed or otherwise provided thereon such as shown in FIG. 2, while an opposite side of the adhesive label may include sections having different adhesives provided thereon such as the sections 5, 7 shown in FIG. 1 and which have removable coverings provided over the adhesives which would be removed at the time the label is to be applied to a container 2. The weaker adhesive may be a repositionable adhesive such as the adhesive used with POST-IT® brand sticky notes, while the stronger adhesive may be a permanent adhesive which strongly bonds to the surfaces of the container such that once the section(s) of the label having the stronger adhesive are bonded to the container these sections may not be removed without destroying or causing some type of permanent, visible damage to the label and/or to the portion(s) of the container to which it is applied. Such weaker and stronger adhesives are well known to persons in the art and are commercially available. As depicted, the label may have two outer sections 5 with the stronger adhesive provided thereon and one center section 7 having the weaker adhesive provided thereon. With such structure, the removable covering on the center section 7 with weaker adhesive may initially be removed so that the section 7 of the label may be carefully positioned on the container 2, and then the coverings on the outer sections 5 may be removed and the end sections 5 bonded to surfaces of the container so as to securely close and seal the opening of the container, such as depicted in FIG. 3. Of course, the adhesive label 4 according to the exemplary embodiment of the invention is not limited to one having one section with weaker adhesive and two sections with stronger adhesive, but may have any desired combination of sections with weaker and stronger adhesives, or the label may have only stronger, permanent adhesive provided thereon.

For using the system according the exemplary embodiment, and as depicted in FIG.3, once containers 6 of pre-packaged goods, such as restaurant-prepared foods, are placed into the container, an opening 9 of the container may be securely closed by collecting/twisting/tying a portion of the container which is adjacent to handles 8 of the container and which defines the opening. Then the label 4 may be accurately provided on such portion of the container by initially using the section 7 of the label having the weaker adhesive provided thereon to position the label relative to the container, and then bonding the sections 5 of the label having the stronger adhesive thereon to the container. When the bag 2 is thus closed and sealed with the label, the section(s) 5 of the label 4 having the stronger adhesive thereon are essentially permanently bonded to the container and cannot be removed without ripping or otherwise damaging the label and parts of the container to which the section(s) 5 are bonded. Also, very importantly it would be very apparent to the recipient of delivered goods whether such a container has been opened during the delivery process after the adhesive label 4 has been applied to the container for closing the opening of the container as depicted in FIG. 3, e.g., the container 2 and/or the label 4 would be permanently, visibly damaged.

The information provided on the one surface of the adhesive label may include various types of information pertaining to the pre-packaged goods, the delivery of same and customer information such as partial phone number, etc., some of which may be helpful for determining if the container(s) in which the pre-packaged goods are being delivered have been tampered with during the delivery process. For example, the information may include identity of the provider of the prepackaged goods 10, identity of the prepackaged goods being delivered, information pertaining to any special characteristics of the pre-packaged goods 11, an order number 12, a number of pre-packaged goods enclosed within the container, a number of containers 2 included with the order 13, identity of the personnel who pre-packaged the goods, identity of the personnel who did a final check of the pre-packaged goods before they were placed into the container, identity of the personnel who applied the adhesive label to the container for closing and sealing same 14, time when the adhesive label was applied to the container and/or when the container was picked up for delivery by delivery personnel, identity of the delivery service and/or delivery personnel 15, notes 11, section(s)/receipt(s) 16 which may be removed from the label by the intended recipient of other persons such as the provider of the pre-packaged goods or by the delivery personnel, and a unique scannable code 17 such as a QR code associated with a downloadable app or the like so that the container 2 may be tracked in real time during the delivery process by any authorized party, including the ultimate recipient of the goods, the delivery service and the provider of the pre-packaged goods. A QR code is quite suitable as the scannable code because it can be recognized/used by smart devices, which a majority of people possess, and the scannable code may be provided more than once on the label as a safeguard in case one of the printed codes is removed or becomes unrecognizable during the packaging or delivery processes.

The system according to the exemplary embodiment may further comprise a printer (not shown), such as a thermal printer or other appropriate type of printer, which is configured to print at least some of the various information on the one surface of the label, e.g., immediately before the label is applied to the container so that the container 2 so that the information can be as accurate as possible. For use in conjunction with the printer, the adhesive labels 4 may be provided in bulk, e.g., multiple blank or substantially blank labels provided on a sheet which can be manipulated by the printer for printing information thereon.

Using a printer to print the labels is advantageous because the printed information can be determined concurrently as or immediately after the pre-packaged goods are enclosed in the container so that the information can be as accurate and legible as possible, unlike information which is generated in advance without any particular specificity to the pre-packaged goods which are being delivered. Another advantage is that the label may contain thereon all the necessary information, in addition to visible, physical integrity of the label, required for the recipients of the delivered goods to know whether the goods are what the recipients ordered and whether it may have been tampered with during the delivery process. Also, the printed information on the label will be more legible and understandable by the recipients of the delivered goods than information conventionally provided on packages from restaurant delivery services, which is often hand written or scribbled onto a package with a marker or other writing instrument.

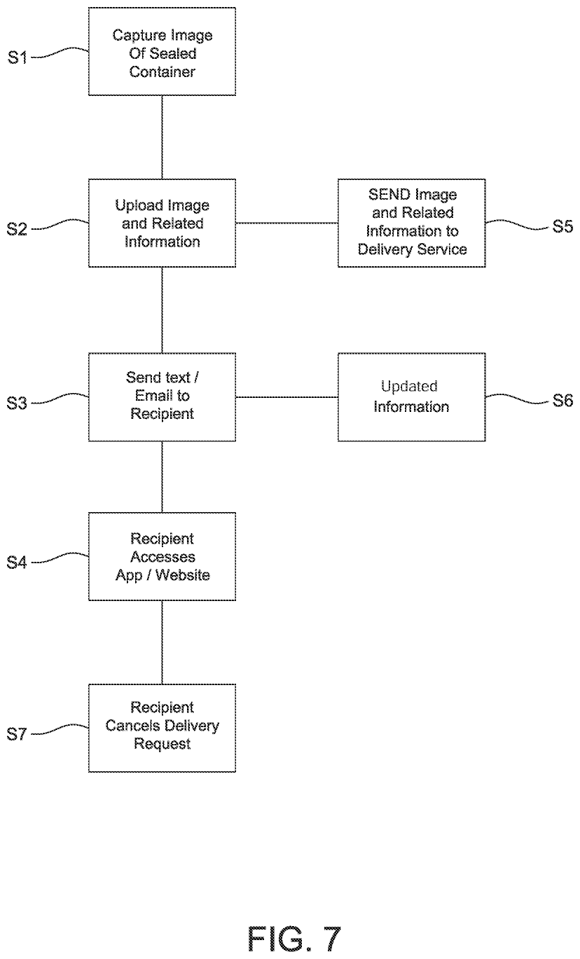

The system according to the exemplary embodiment of the invention may further include a smart phone application, a publicly accessible web site, a web address or the like through which customers and other users may conveniently take various actions relating to the pre-packaged goods, including placing orders for pre-packaged goods to be delivered to the users, tracking the orders after they have been made and determining the status of the delivery orders. Such a smart phone application is disclosed in relation the FIG. 7 of the present application and may be associated with the scannable code(s) 17 provided on the label 4. For example, the provider of the pre-packaged goods may scan the scannable code with a smart phone or other device at the time the goods have been placed in the container 2 and sealed with the label 4 and are ready for pick up/delivery, and upload image(s) of the sealed container along with any other desired information to an associated app or the like such as intended delivery time, while simultaneously sending a text and/or link to the intended recipient which permits the intended recipient to access the image and other information if desired. The uploaded image(s) of the container and other information provides additional means by which the intended recipients of the delivered goods, may easily determine various things, including whether the container as ultimately delivered has been tampered with, when the container is likely to arrive, etc. This would permit the intended recipient to quickly determine in real time the status of an order placed by the user. Also, the provider of the pre-packaged goods may give the intended recipient an option to cancel the delivery order and choose to pick up the container of pre-packaged goods themselves rather than wait for the delivery, and could even offer the intended recipient a perk for doing so, e.g., 10% discount on the order, coupon for free side dish on next order, etc. Similarly, the provider of the pre-packaged goods may also send a text to the delivery service advising when the order is ready to be picked up and delivered.

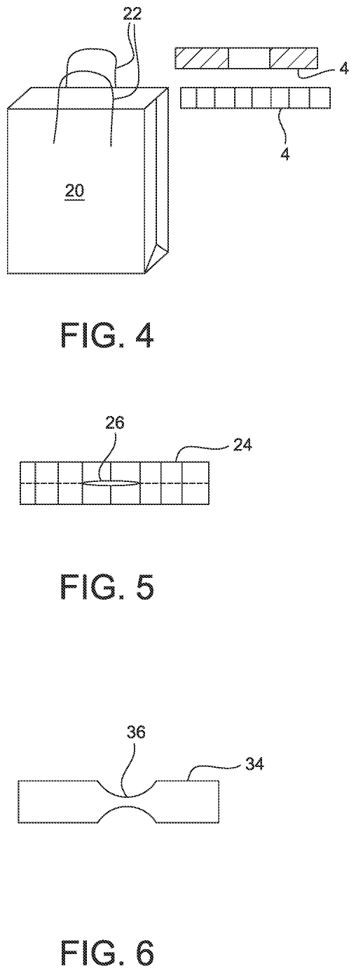

With reference to FIG. 4, there is shown another exemplary embodiment of an anti-tampering system according to the present invention. This embodiment includes most aspects of the exemplary embodiment of FIGS. 1-3, but is different from the embodiment of FIGS. 1-3 in relation to the type of container used and how the container may be closed and sealed using more than one of the adhesive labels. Particularly, the container 20 in this embodiment is a bag with opposing handles 22 provided on and projecting from opposite sides of an upper opening of the bag. While the upper opening of the bag may be closed and sealed using a single adhesive label 4, e.g., by folding the upper portion of the bag including the handles over and then applying the label over the folded portion, this would interfere with use of the handles for carrying and transporting the container and may not be convenient. In order to avoid this inconvenience, a plurality of the labels 4 may be used for closing and sealing the container. For example, FIG. 4 depicts two of the adhesive labels. These may be selectively applied to upper portions of the container 20 on opposite sides of the handles and across the container opening for closing and sealing same in various manners which would permit the handles 22 to still be available for use in carrying and transporting the container. For examples, portions of the two labels may be respectively adhered lengthwise along outer surfaces of the upper portions of the container on opposite sides of the upper opening, including over portions of the handles 22, such that the remaining portions of the labels project above the upper opening of the container, and then adhering the projecting portions of the labels to each other. As another example, the two labels may be separately applied widthwise to upper portions of the container crossing the upper opening from one side of the container to the other, with one of the labels disposed outward of first sides of the handles 22 and the other label disposed outward of second sides of the handles 22. If desired, a third label, could be applied widthwise to upper portions of the container crossing the upper opening from one side of the container to the other between the two sides of the handles.

FIG. 5 depicts another embodiment of a label 24 according to the present invention which may be used together with the container 20 in FIG. 4. The label 24 includes a slot or cut in a central portion thereof that would receive the projecting portions of the handles 22 therethrough, starting with the upper portions of the handles which project above the opening of the bag. After the label is slid down over the handles, it would then be folded in two lengthwise so that opposing halves of the label would be adhered to the outer surfaces of the container along opposite sides of the upper opening of the container. The label 24 would otherwise include all of the information included with the label 4 in FIG. 2. Again, however, the anti-tampering system according to the present invention may be applied to any type of container as mentioned above, and an appropriate number of labels, of any appropriate size or shape may be used for sealing any given container provided that it would not be possible to access the pre-packaged goods in the sealed container with causing some permanent, visible damage to the container and/or the label. Also. if multiple labels are to be used for sealing a given container, it is possible to modify the information provided on the labels to reflect this.

Referring to FIG. 6, there is shown a plan view of another label 34 which may be used according to another exemplary embodiment of the present invention and which includes a weakened portion 36 which may be easily ruptured. Here the weakened portion 36 has a reduced width in comparison to other portions of the label, but the weakened portion 36 could be formed in any other appropriate manner, e.g., a rupture line of perforations may be provided across a portion of the label. Also, the weakened portion may also be one having the weaker adhesive provided thereon to lessen any chance that the weaker portion may be unintentionally ruptured while the label is being applied to the container for sealing same. The label 34 having the weakened portion is advantageous for a couple reasons. First, it makes it easy for the intended recipient to access the goods in the container after it is delivered to the recipient. Also, the weakened portion is more susceptible to being permanently, visibly damaged if someone other than the intended recipient attempts to remove the label from the container.

Referring to FIG. 7, there is shown a flowchart of a process for uploading and transmitting images of the sealed container, and other real time information regarding prepackaged goods which are being delivered, to a smart phone application, a publicly accessible web site or web address associated with tracking code(s) provided on the label according to an exemplary embodiment of the present invention. As depicted, at step S1 once personnel of a restaurant or other provider has enclosed and sealed the prepackaged goods in a container of a system according to an embodiment of the present invention, the personnel may then capture image(s) of the closed and sealed container using a camera, e.g., a camera in a smart phone device. The captured image may depict portions of the sealed container having the adhesive label(s) applied thereto and may capture some or all of the information provided on the label(s). At step S2, the personnel may then upload the image(s) and other real time information regarding prepackaged goods which are being delivered to a smart phone application, a publicly accessible web site or web address associated with tracking code(s) provided on the label(s), at step S3 a text or email is forwarded to the intended recipient of the goods being delivered informing the intended recipient of the availability of the image(s) of the closed/sealed container and the other related information on the smart phone application, publicly accessible web site or web address, and may include a link which will directly access the uploaded information. At step S4 the intended recipient accesses the same. In addition to sending a text or email to the intended recipients at step S3, at step S5 the personnel may also send a text or email to a delivery service so that delivery service will be advised that the closed and sealed container of the prepackaged goods is available for being picked up and delivered to the intended recipients. Further, at step S6 the delivery service may provide an update on the status of the delivery to the goods provider, such as a delayed delivery time, and at step S3 the goods provider may send another text or email to the intended recipients providing the updated information. Still further, the information uploaded by the provider may give the intended recipients an option to come pick up the sealed container of goods themselves, while cancelling the delivery service, and may offer the intended recipients an incentive for picking up the goods themselves, e.g., a 10% discount on the order, a coupon for a free side dish on a next order, etc. At step S7, the intended recipients may inform the provider that the recipients choose to pick up the sealed container of goods themselves and cancel the delivery service.

FIGS. 8-10 show a workflow program (application flow chart). FIG. 8 is a view of a customer segment of a workflow program. FIG. 9 is a view of a vendor segment of a workflow program. FIG. 10 is a view of a delivery segment of a workflow program.

### Restaurant Order Control (ROC) Axis

With reference to FIGS. 8-10, Restaurant Order Control (ROC) Axis is explained. The Restaurant Order Control (R.O.C.) Axis is a food delivery system designed to provide the three following major points with its service.
Customer safety—ensure safety and satisfaction of the customer throughout the entire process of food preparation and delivery.
Information transparency—provide information to the customer at every stage of the process to provide peace of mind to the customer.
Restaurant control—provide sufficient control over the delivery process to the restaurants to ensure that the delivery process does not negatively impact restaurant function.

### High-Level Workflow

The R.O.C. Axis software system/workflow program consists of three separate applications that work together. There is an application for customer use, another for restaurants, and a third for drivers. The overall workflow of the system is described by the following process.
1. Customer places order through R.O.C. Axis application.
   a. A graphical interface allows the customer to easily place order with custom options.
   b. The customer can pay for food and delivery charges within the application.
2. Restaurant sends food preparation time estimate to customer shortly after order is placed.
   a. The restaurant does this by selecting the order form their queue in the restaurant application and entering a time estimate that will be sent to the customer.
   b. The time estimate can be updated at any time be the restaurant and the customer is notified each time it is updated. Restaurants can offer delivery or pick-up options with the possibility of incentives.
3. Restaurant sends picture of food to customer once the order is fully prepared.
   a. One or more seals with a QR code and other information corresponding to the order is printed and used to seal the order after the picture (or video) is taken. Labels for individual food items may also be printed as well.
   b. The third-party delivery service is notified that the order is ready so it can dispatch drivers to pick up the food from the restaurant.
4. Driver sends food delivery time estimate to customer when the order is picked up.
   a. The driver does this by scanning the QR code on the food container in the driver application and entering a time estimate that will be sent to the customer.
   b. The time estimate can be updated at any time by the driver and the customer is notified each time it is updated.
5. Driver sends confirmation of delivery to customer after the order is delivered.
   a. The customer can leave feedback for the restaurant or the driver once the order is received.
   b. If the customer leaves negative feedback about a restaurant or other origin of order, the restaurant will be given the opportunity to correct or dispute the issue with the customer. The negative feedback against a restaurant is only published if the restaurant is not able to resolve the issue. The ternary relationship between customers, restaurants, and drivers allows any of them to rate each other based on performance and satisfaction of working together.

### Segments/Workflows of the Workflow Program

### Customer Workflow (FIG. 8)

1. Customer places order through R.O.C. Axis application.
2. Customer receives food preparation time estimate from restaurant shortly after order is placed.
3. Customer receives picture of food from restaurant once the order is fully prepared.
4. Customer receives food delivery time estimate from driver when the order is picked up.
5. Customer receives confirmation of delivery from driver after the order is delivered.

### Restaurant Workflow (FIG. 9)

1. Restaurant receives order from customer.
2. Restaurant sends food preparation time estimate to customer shortly after order is placed.
3. Restaurant sends picture of food to customer once the order is fully prepared.

### Driver Workflow (FIG. 10)

1. Driver is assigned to order by a third-party delivery service.
2. Driver sends food delivery time estimate to customer when the order is picked up.
3. Driver sends confirmation of delivery to customer after the order is delivered.

The present invention is not limited in its application to the details of construction and to the dispositions of the components set forth in the foregoing description or illustrated in the appended drawings in association with the present exemplary embodiments of the invention. The present invention is capable of other embodiments and of being practiced and carried out in various ways. In addition, it is to be understood that the phraseology and terminology employed herein are for the purposes of illustration and example, and should not be regarded as limiting.

As such, those skilled in the art will appreciate that the concepts, upon which this disclosure is based, may readily be utilized as a basis for the designing of other structures, methods and systems for carrying out the several purposes of the present invention. It is important, therefore, that the claims be regarded as including such equivalent constructions

Although the present invention has been described herein with respect to specific illustrative embodiment, the foregoing description is intended to illustrate, rather than to limit the invention. Those skilled in the art will realize that many modifications of the preferred embodiment could be made which would be operable. All such modifications, which are within the scope of the claims, are intended to be within the scope and spirit of the present invention.

What is claimed is:

1. A tamper-resistant system for delivering pre-packaged goods prepared by a vendor, comprising
a container configured to receive pre-packaged goods therein;
a label configured to be applied across an opening of the container such that the pre-packaged goods received in the container are not accessible without visibly, permanently damaging one or both of the label and the container; and
a workflow program comprising a plurality of segments including a customer segment to be used by customers and intended recipients, a vendor segment to be used by vendor who is preparer and packager of goods, and a delivery segment to be used delivery personnel;
wherein the vendor segment is configured to produce said label having information provided thereon regarding the pre-packaged goods, a person who placed pre-packaged goods in said container, an entity who prepared the pre-packaged goods, a delivery personnel, an intended recipient, and a scannable code; and to selectively provide real time information pertaining the pre-packaged goods and a status of delivery of the pre-packaged goods to the intended recipient including contact information of the delivery personnel;
wherein during the delivery process, the delivery personnel is allowed to contact via a mobile device by scanning the scannable code which includes contact information of the intended recipient without the delivery personnel gaining access to the contact information of the intended recipient.

2. The tamper-resistant system for delivering pre-packaged goods according to claim 1, wherein said vendor is a restaurant.

3. The tamper-resistant system for delivering pre-packaged goods according to claim 1, wherein said pre-packaged goods are food items.

4. The tamper-resistant system for delivering pre-packaged goods according to claim 1, wherein said customer segment is configured to permit a customer to place an order for goods via the vendor segment, to receive confirmation of order from the vendor segment, and to inform intended recipient of placing of the order.

5. The tamper-resistant system for delivering pre-packaged goods according to claim 1, wherein said vendor segment is configured to receive customer order for goods, to acknowledge the receipt of the order; provide update on preparation of goods including images of prepared goods, produce the label corresponding to the order, and provide image of the container the corresponding label placed thereon, update delivery personnel to pick up the container for delivery, update the customer and the intended recipient of the order including information of delivery personnel.

6. The tamper-resistant system for delivering pre-packaged goods according to claim 1, wherein said delivery segment is configured to receive information from the vendor for delivery of the container, to selectively contact the vendor and intended recipient using a mobile device operable to scan the scannable code on the label about status of delivery of goods including any delay in delivery without the delivery personnel gaining access to the contact information of the intended recipient.
